(19) United States
(12) Patent Application Publication
(10) Pub. No.: US 2026/0147219 A1
(43) Pub. Date: May 28, 2026

(54) OPTICAL LENS ASSEMBLY AND ELECTRONIC DEVICE

(71) Applicant: NEWMAX TECHNOLOGY CO., LTD., Taichung City (TW)

(72) Inventors: Ching-Yun HUANG, Taichung City (TW); Fei-Hsin TSAI, Taichung City (TW)

(21) Appl. No.: 19/052,311

(22) Filed: Feb. 13, 2025

(30) Foreign Application Priority Data
Nov. 22, 2024 (TW) 113145085

(51) Int. Cl. G02B 27/09; G02B 27/01; G02B 27/28

(52) U.S. Cl. CPC G02B 27/0955; G02B 27/0172; G02B 27/283

(57) ABSTRACT

An optical lens assembly includes: in order a visual side to an image source side: a first lens, a reflective polarizer, a second lens, a partial-reflective-partial-transmissive element and a third lens, and further includes a phase retarder disposed between the reflective polarizer and the partial-reflective-partial-transmissive element. The optical lens assembly may become lightweight and have good image quality when satisfying a specific condition.

### BACKGROUND

### Field of the Invention

The present invention relates to an optical lens assembly and electronic device, and more particularly to an optical lens assembly applicable to electronic devices (for example, but not limited to, head-mounted electronic devices).

### Description of Related Art

With the development of the semiconductor industry, the functions of various consumer electronic products are increasingly powerful. Moreover, various services of the software application end emerge. These enable consumers to have more choices. Virtual reality (VR) technology emerges when the market is no longer satisfied with handheld electronic products. Nowadays, the application of virtual reality opens up a blue ocean market for consumer electronics, and in the application field of virtual reality, the first commercialized project is the head-mounted display.

However, the current head-mounted displays are heavy and have poor image quality.

The present invention mitigates and/or obviates the aforementioned disadvantages.

### SUMMARY

The objective of the present invention is to provide an optical lens assembly and an electronic device, whereby the number of lenses can be reduced by folding the light path, so as to the reduce the weight of the device, and provide better image quality.

Therefore, an optical lens assembly in accordance with an embodiment of the present invention includes: a first lens with positive refractive power, including a visual-side surface being convex in a paraxial region thereof; a reflective polarizer; a phase retarder (that is, a first phase retarder); a second lens with positive refractive power, including an image source-side surface being convex in a paraxial region thereof; a partial-reflective-partial-transmissive element; and a third lens with positive refractive power, including a visual-side surface being convex in a paraxial region thereof. The first lens, the reflective polarizer, the second lens, the partial-reflective-partial-transmissive element and the third lens are disposed in order from a visual side to an image source side, and the phase retarder is disposed between the reflective polarizer and the partial-reflective-partial-transmissive element.

In the optical lens assembly, a focal length of the optical lens assembly is f, an absolute value of a displacement in parallel to an optical axis from an intersection between the image source-side surface of the second lens and the optical axis to a maximum effective radius position on the image source-side surface of the second lens is TDP4, an absolute value of a displacement in parallel to the optical axis from an intersection between the visual-side surface of the third lens and the optical axis to a maximum effective radius position on the visual-side surface of the third lens is TDP5, a thickness of the first lens along the optical axis is CT1, a thickness of the second lens along the optical axis is CT2, a thickness of the third lens along the optical axis is CT3, a maximum effective radius of the image source-side surface of the second lens is CA4, a distance from the first lens to the second lens along the optical axis is T12, a radius of curvature of the image source-side surface of the second lens is R4, a radius of curvature of the visual-side surface of the third lens is R5, a distance from the visual-side surface of the first lens to an image plane of the optical lens assembly-along the optical axis is TL, a distance from an image source-side surface of the third lens to the image plane along the optical axis is BFL, a maximum image height of the optical lens assembly is IMH, a maximum field of view of the optical lens assembly is FOV, and at least one of the following conditional formulas is satisfied:

$$0.51 < TDP 4 / TDP 5 < 3.03 ;$$

$$0.96 < f / IMH < 1 \text{.62} ;$$

$$1.17 < TL / IMH < 2 \text{.03} ;$$

$$1.99 {mm}^{2} / ° < TL ⋆ IMH / FOV < 3.46 {mm}^{2} / ° ;$$

$$0.36 < ( CT 1 + T 12 + CT 2 ) / TL < 0 \text{.75} ;$$

$$2.91 < R 5 / CT 3 < 7 \text{.03} ;$$

$$2.03 < CA 4 / f < 3 \text{.33} ;$$

$$- 2.8 \; 5 < R 4 / R 5 < - 0 \text{.95} ;$$

$$0.57 < CT 2 / CT 3 < 1 \text{.92} ;$$

$$0.7 < ( CT 1 + CT 2 ) / ( CT 3 + B F L ) < 2 \text{.08} ;$$

$$- 17. 13 < ( R 4 / TDP 4 ) + ( R 5 / TDP 5 ) < 19 \text{.00} ;$$

$$4.26 ° / mm < FOV / f < 7.48 ° / mm ; and$$

$$46.73 mm < CA 4 ⋆ ( T L - BFL ) / IMH < 81.32 mm .$$

When TDP4/TDP5 is satisfied, it is conducive to effectively improving the distortion of the optical lens assembly, reducing the aberration, and enhancing the performance.

When f/IMH is satisfied, it is conducive to achieving a better ratio of the focal length of the optical lens assembly to the displaying size of a display.

When TL/IMH is satisfied, it is conducive to achieving a better ratio of the total length of the optical lens assembly to the displaying size of the display.

When TL*IMH/FOV is satisfied, it is conducive to minimizing the total length of the optical lens assembly and providing a more appropriate field of view.

When (CT1+T12+CT2)/TL is satisfied, it is conducive to better distributing the spatial configuration from the first lens to the second lens, so as to maintain the formability of the two lenses and the assembly space for the two lenses.

When R5/CT3 is satisfied, it is conducive to achieving a better ratio of a radius of curvature of the third lens to the thickness of the third lens on the optical axis, so as to maintain the formability of the third lens.

When CA4/f is satisfied, it is conducive to providing the desired focal length for the lens device and optimizing the effective radius of the lens.

When R4/R5 is satisfied, it is conducive to preventing the radius of curvature from being too small, and to reducing the sensitivity to the assembly tolerance as the two radii of curvature are conditioned by each other.

When CT2/CT3 is satisfied, it is conducive to achieving a better thickness ratio of the second lens to the third lens, so as to maintain the formability of the two lenses and the assembly space for the two lenses.

When (CT1+CT2)/(CT3+BFL) is satisfied, it is conducive to achieving a better ratio of space allocation of the lens device.

When (R4/TDP4)+(R5/TDP5) is satisfied, it is conducive to effectively improving the distortion of the optical lens assembly, reducing the aberration of the optical lens assembly, and enhancing the performance.

When FOV/f is satisfied, it is conducive to achieving a better ratio of the field of view to the focal length of the optical lens assembly, so as to optimize the performance of the lens device.

When CA4*(TL-BFL)/IMH is satisfied, it is conducive to minimizing the optical lens assembly.

Optionally, the optical lens assembly has, for example, but not limited to, a total of three lenses with refractive power.

Moreover, an electronic device in accordance with an embodiment of the present invention includes a housing, the aforementioned optical lens assembly disposed in the housing, an image source disposed on the image source plane of the optical lens assembly in the housing, and a controller disposed in the housing and electrically connected to the image source.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A is a schematic view of an optical lens assembly in accordance with a first embodiment of the present invention;

FIG. 1B is a schematic view of a light path of a chef ray in the optical lens assembly in FIG. 1A;

FIG. 2 is a schematic view of an optical lens assembly in accordance with a second embodiment of the present invention;

FIG. 3 is a schematic view of an optical lens assembly in accordance with a third embodiment of the present invention;

FIG. 4 is a schematic view of an optical lens assembly in accordance with a fourth embodiment of the present invention;

FIG. 5 is a schematic view of an optical lens assembly in accordance with a fifth embodiment of the present invention;

FIG. 6 is a schematic view of an optical lens assembly in accordance with a sixth embodiment of the present invention; and

FIG. 7 is a schematic view of a head-mounted electronic device in accordance with an embodiment of the present invention.

### DETAILED DESCRIPTION

An optical lens assembly in accordance with the present invention includes, in order from a visual side to an image source side: a first lens, a reflective polarizer, a second lens, a partial-reflective-partial-transmissive element and a third lens, and further includes a phase retarder (that is, a first phase retarder) located between the reflective polarizer and the partial-reflective-partial-transmissive element.

The first lens with positive refractive power, including a visual-side surface being convex in a paraxial region thereof.

The second lens with positive refractive power, including an image source-side surface being convex in a paraxial region thereof.

The third lens with positive refractive power, including a visual-side surface being convex in a paraxial region thereof.

In the optical lens assembly, a focal length of the optical lens assembly is f, an absolute value of a displacement in parallel to an optical axis from an intersection between the image source-side surface of the second lens and the optical axis to a maximum effective radius position on the image source-side surface of the second lens is TDP4, an absolute value of a displacement in parallel to the optical axis from an intersection between the visual-side surface of the third lens and the optical axis to a maximum effective radius position on the visual-side surface of the third lens is TDP5, a thickness of the first lens along the optical axis is CT1, a thickness of the second lens along the optical axis is CT2, a thickness of the third lens along the optical axis is CT3, a maximum effective radius of the image source-side surface of the second lens is CA4, a distance from the first lens to the second lens along the optical axis is T12, a radius of curvature of the image source-side surface of the second lens is R4, a radius of curvature of the visual-side surface of the third lens is R5, a distance from the visual-side surface of the first lens to an image plane of the optical lens assembly-along the optical axis is TL, a distance from an image source-side surface of the third lens to the image plane along the optical axis is BFL, a maximum image height of the optical lens assembly is IMH, a maximum field of view of the optical lens assembly is FOV, and at least one of the following conditional formulas is satisfied:

$$0.51 < TDP 4 / TDP 5 < 3.03 ;$$

$$0.96 < f / IMH < 1 \text{.62} ;$$

$$1.17 < TL / IMH < 2 \text{.03} ;$$

$$1.99 {mm}^{2} / ° < TL ⋆ IMH / FOV < 3.46 {mm}^{2} / ° ;$$

$$0.36 < ( CT 1 + T 12 + CT 2 ) / TL < 0 \text{.75} ;$$

$$2.91 < R 5 / CT 3 < 7 \text{.03} ;$$

$$2.03 < CA 4 / f < 3 \text{.33} ;$$

$$- 2.85 < R 4 / R 5 < - 0 \text{.95} ;$$

$$0.57 < CT 2 / CT 3 < 1 \text{.92} ;$$

$$0.7 < ( CT 1 + CT 2 ) / ( CT 3 + B F L ) < 2 \text{.08} ;$$

$$- 17.13 < ( R 4 / TDP 4 ) + ( R 5 / TDP 5 ) < 19 \text{.00} ;$$

$$4.26 ° / mm < FOV / f < 7.48 ° / mm ; and$$

$$46.73 mm < CA 4 ⋆ ( T L - BFL ) / IMH < 81.32 mm .$$

### First Embodiment

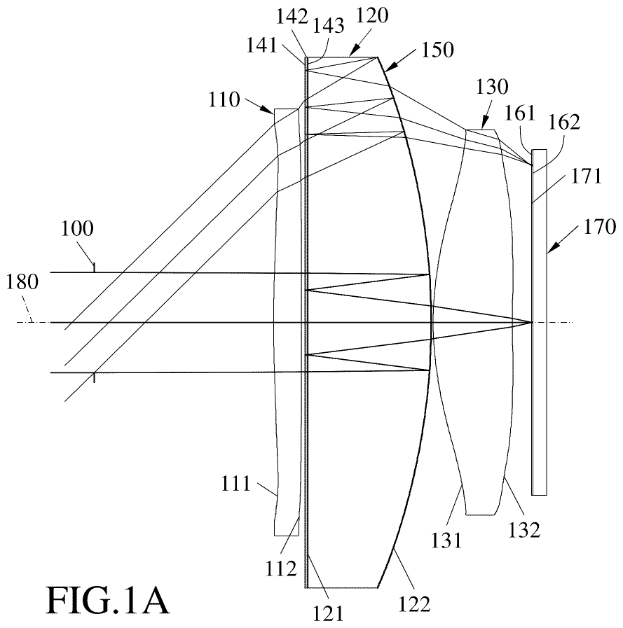

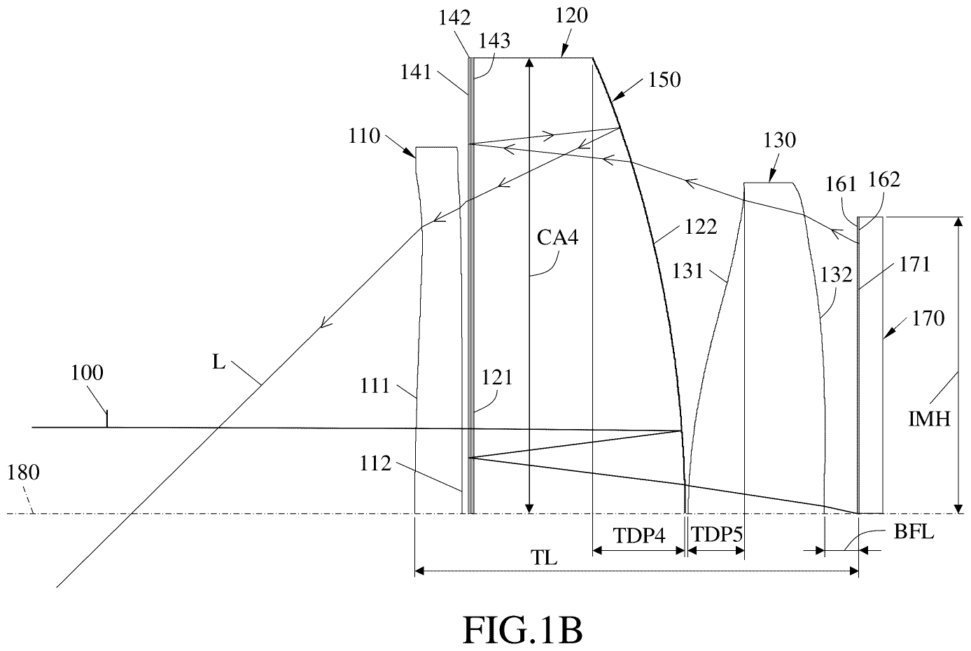

Referring to FIGS. 1A and 1B, an optical lens assembly in accordance with a first embodiment of the present invention includes, in order from a visual side to an image source side along an optical axis 180: a stop 100, a first lens 110, a first absorptive polarizer 141, a reflective polarizer 142, a first phase retarder 143, a second lens 120, a partial-reflective-partial-transmissive element 150, a third lens 130, a second phase retarder 161, a second absorptive polarizer 162 and an image source plane 171. The optical lens assembly has, for example, but not limited to, a total of three lenses with refractive power.

The stop 100 may be located in a position where the user's eyes are located for viewing an image.

The first lens 110 with positive refractive power includes a visual-side surface 111 and an image source-side 112, the visual-side surface 111 of the first lens 110 is convex in a paraxial region thereof, the image source-side surface 112 of the first lens 110 is convex in a paraxial region thereof, the visual-side surface 111 and the image source-side surface 112 of the first lens 110 are aspheric, and the first lens 110 is made of plastic.

The second lens 120 with positive refractive power includes a visual-side surface 121 and an image source-side surface 122, the visual-side surface 121 of the second lens 120 is flat in a paraxial region thereof, the image source-side surface 122 of the second lens 120 is convex in a paraxial region thereof, the image source-side surface 122 of the second lens 120 is aspheric, and the second lens 120 is made of plastic.

The third lens 130 with positive refractive power includes a visual-side surface 131 and an image source-side surface 132, the visual-side surface 131 of the third lens 130 is convex in a paraxial region thereof, the image source-side surface 132 of the third lens 130 is concave in a paraxial region thereof, the visual-side surface 131 and the image source-side surface 132 of the third lens 130 are aspheric, and the third lens 130 is made of plastic.

A visual-side surface of the first absorptive polarizer 141 faces the first lens 110, an image source-side surface of the first absorptive polarizer 141 is jointed with a visual-side surface of the reflective polarizer 142, an image source-side surface of the reflective polarizer 142 is jointed with a visual-side surface of the first phase retarder 143, and an image source-side surface of the first phase retarder 143 is jointed with the visual-side surface 121 of the second lens 120. The first phase retarder 143 is, for example, but not limited to, a quarter-wave plate.

A visual-side surface of the partial-reflective-partial-transmissive element 150 is jointed with the image source-side surface 122 of the second lens 120 and has an average reflectance of at least 30%, preferably 50%, in the wavelength range of visible light. The average reflectance here is an average value of different reflectance of the partial-reflective-partial-transmissive element 150 for different wavelengths.

A visual-side surface of the second phase retarder 161 faces the partial-reflective-partial-transmissive element 150, and an image source-side surface of the second phase retarder 161 is jointed with a visual-side surface of the second absorptive polarizer 162. The second phase retarder 161 is, for example, but not limited to, a quarter-wave plate.

An image source-side surface of the second absorptive polarizer 162 is jointed with the image source plane 171.

The optical lens assembly works in cooperation with an image source 170 disposed on the image source plane 171 located between the second absorptive polarizer 162 and the image source 170. In the present embodiment, the type of the image source 170 is, for example, but not limited to, an OLED display, a LED display, a liquid crystal display, or other displays.

The curve equation for the aspheric surface profiles of the respective lenses of the first embodiment is expressed as follows:

$$z ( h ) = \frac{{ch}^{2}}{1 + {[ 1 ( k + 1 ) {c}^{2} {h}^{2} ]}^{0.5}} \sum ( {A}_{i} ) \cdot ( {h}^{i} )$$

wherein:
z represents the value of a reference position at a height of h with respect to a vertex of the surface of a lens along the optical axis 180;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 180;
k represents the conic constant; and
Ai represents the i-th order aspheric coefficient.

The optical lens assembly of the first embodiment utilizes the configuration and arrangement of the absorptive polarizer, the reflective polarizer, the phase retarders, the partial-reflective-partial-transmissive element and the lenses to fold the light path thereof by the transmission and reflection of light to shorten the length of the optical lens assembly required for forming an image without affecting the image quality. In a light path L in FIG. 1B, a linearly-polarized beam from the image source plane 171 turns to a circularly-polarized beam after passing through the second absorptive polarizer 162 and the second phase retarder 161. The circularly-polarized beam leaving the second phase retarder 161 is projected onto the partial-reflective-partial-transmissive element 150 after passing through the third lens 130, a component of the circularly-polarized beam projected onto the partial-reflective-partial-transmissive element 150 passes through the partial-reflective-partial-transmissive element 150, the second lens 120 and the first phase retarder 143 to form a linearly-polarized light component. Then, this linearly-polarized light component is reflected by the reflective polarizer 142 and passes through the first phase retarder 143 and the second lens 120 to turn to a circularly-polarized light component. A part of the circularly-polarized light component is reflected by the partial-reflective-partial-transmissive element 150 and then passes through the second lens 120, the first phase retarder 143, the reflective polarizer 142, the first absorptive polarizer 141 and the first lens 110 to turn to linearly-polarized image light. Finally, the linearly-polarized image light transmits to the user's eyes, so as to form an image visually.

Please refer to Tables 1-4, Table 1 shows the detailed optical data of the elements of the optical lens assembly of the first embodiment, Table 2 shows the aspheric coefficients of the aspherical surfaces of the elements of the optical lens assembly of the first embodiment, Table 3 shows the remaining parameters of the optical lens assembly of the first embodiment and the values thereof, and the values of the parameters in Tables 1 and 3 meet the conditional formulas of Table 4. A focal length of the first lens 110 is f1, a focal length of the second lens 120 is f2, a focal length of the third lens 130 is f3, the remaining parameters may be defined by to the above explanation and will not be provided again.

TABLE 1
f = 16.09 mm, EPD (entrance pupil diameter) = 8.00 mm, FOV = 94.70°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 13.000 | — | — | — |
| 1 | First lens | 165.691 | 2.000 | 1.544 | 55.9 | Refraction |
| 2 | | −1153.035 | 0.180 | — | — | Refraction |
| 3 | First absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | First phase | Infinity | 0.100 | 1.533 | 56.0 | Refraction |
| | retarder | | | | | |
| 6 | Second lens | Infinity | 8.929 | 1.544 | 55.9 | Refraction |
| 7 | Partial- | −60.298 | −8.929 | Mirror | | Reflection |
| | reflective-partial- | | | | | |
| | transmissive | | | | | |
| | element | | | | | |
| 8 | First phase | Infinity | −0.100 | 1.533 | 56.0 | Refraction |
| | retarder | | | | | |
| 9 | Reflective | Infinity | −0.100 | 1.533 | 56.0 | Refraction |
| 10 | polarizer | Infinity | 0.100 | Mirror | | Reflection |
| 11 | First phase | Infinity | 0.100 | 1.533 | 56.0 | Refraction |
| | retarder | | | | | |
| 12 | Second lens | Infinity | 8.929 | 1.544 | 55.9 | Refraction |
| 13 | Partial- | −60.298 | 0.150 | — | — | Refraction |
| | reflective-partial- | | | | | |
| | transmissive | | | | | |
| | element | | | | | |
| 14 | Third lens | 29.936 | 5.744 | 1.544 | 55.9 | Refraction |
| 15 | | 81.205 | 1.274 | — | — | Refraction |
| 16 | Second phase | Infinity | 0.100 | 1.533 | 56.0 | Refraction |
| | retarder | | | | | |
| 17 | Second | Infinity | 0.100 | 1.533 | 56.0 | Refraction |
| | absorptive | | | | | |
| | polarizer | | | | | |
| 18 | Image source | Infinity | — | — | — | — |
| | plane | | | | | |

The reference wavelength is 550 nm.

TABLE 2
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 1.5191E−06 | 1.7722E−05 | 0.0000E+00 |
| A6: | 2.2749E−09 | −2.4650E−07 | 0.0000E+00 |
| A8: | −3.9116E−09 | −4.8766E−10 | 0.0000E+00 |
| A10: | 6.2332E−11 | 3.0117E−11 | 0.0000E+00 |
| A12: | −4.1050E−13 | −2.1948E−13 | 0.0000E+00 |
| A14: | 1.2258E−15 | 6.3734E−16 | 0.0000E+00 |
| A16: | −1.3781E−18 | −6.6526E−19 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 7, 13 | 14 | 15 |
|---|---|---|---|
| K: | 0.0000E+00 | 0.0000E+00 | 0.0000E+00 |
| A2: | 0.0000E+00 | 0.0000E+00 | 0.0000E+00 |
| A4: | −1.2083E−06 | −1.7027E−05 | −3.1975E−04 |
| A6: | 1.4896E−08 | −6.0648E−07 | 6.0671E−06 |
| A8: | −3.9189E−11 | 1.4551E−08 | −6.8269E−08 |
| A10: | −1.9410E−13 | −1.5387E−10 | 4.3195E−10 |
| A12: | 1.3874E−15 | 7.6311E−13 | −1.5196E−12 |
| A14: | −2.9791E−18 | −1.7302E−15 | 2.8377E−15 |
| A16: | 2.1670E−21 | 1.3760E−18 | −2.3206E−18 |
| A18: | 0.0000E+00 | 0.0000E+00 | 0.0000E+00 |
| A20: | 0.0000E+00 | 0.0000E+00 | 0.0000E+00 |

TABLE 3

| | | | | | | | |
|---|---|---|---|---|---|---|---|
| f1[mm] | 264.62 | T12[mm] | 0.18 | R5[mm] | 29.94 | TL[mm] | 18.78 |
| f2[mm] | 110.08 | CT2[mm] | 8.93 | TDP4[mm] | 3.03 | BFL[mm] | 1.47 |
| f3[mm] | 83.26 | CT3[mm] | 5.74 | TDP5[mm] | 2.35 | IMH[mm] | 12.56 |
| CT1[mm] | 2.00 | R4[mm] | −60.30 | CA4[mm] | 42.40 | — | — |

TABLE 4

| | | | | | |
|---|---|---|---|---|---|
| TDP4/TDP5 | 1.29 | R5/CT3 | 5.21 | (R4/TDP4) + | −7.16 |
| | | | | (R5/TDP5) | |
| f/IMH | 1.28 | CA4/f | 2.64 | FOV/f[°/mm] | 5.89 |
| TL/IMH | 1.49 | R4/R5 | −2.01 | CA4*(TL − | 58.41 |
| | | | | BFL)/IMH[mm] | |
| TL*IMH/FOV | 2.49 | CT2/CT3 | 1.55 | — | — |
| [mm²/°] | | | | | |
| (CT1 + T12 + | 0.59 | (CT1 + CT2)/ | 1.51 | — | — |
| CT2)/TL | | (CT3 + BFL) | | | |

In Table 1, the units of the radius of curvature, the thickness, the gap and the focal length are expressed in mm, and the surface numbers 18-0 respectively represent the surfaces through which the light sequentially transmits from the image source plane 171 to the stop 100 along the light path L, wherein the surface 0 represents a gap between the stop 100 (or the user's eyes) and the first lens 110 along the optical axis 180; the surface 1 represents the thickness of the first lens 110 along the optical axis 180 (i.e., thickness CT1); the surface 2 represents a gap between the first lens 110 and the first absorptive polarizer 141 along the optical axis 180; the surface 3 represents the thickness of the first absorptive polarizer 141 along the optical axis 180; the surfaces 4, 9 and 10 represent the thickness of the reflective polarizer 142 along the optical axis 180; the surfaces 5, 8 and 11 represent the thickness of the first phase retarder 143 along the optical axis 180; the surfaces 6 and 12 represent the thickness of the second lens 120 along the optical axis 180; the surface 7 represents a gap between the partial-reflective-partial-transmissive element 150 and the visual-side surface 121 of the second lens 120 along the optical axis 180, and this gap is equivalent to the thickness of the second lens 120 along the optical axis 180; the surface 13 represents the thickness of the reflective-partial-transmissive element 150 along the optical axis 180; the surface 14 represents the thickness of the third lens 130 along the optical axis 180; the surface 15 represents a gap between the third lens 130 and the second phase retarder 161 along the optical axis 180; the surface 16 represents the thickness of the second phase retarder 161 along the optical axis 180; and the surface 17 represents the thickness of the second absorptive polarizer 162 along the optical axis 180. The gaps and thicknesses having a positive sign in Table 1 denote the transmission direction of light is toward the stop 100, and the gaps and thicknesses having a negative sign in Table 1 denote the transmission direction of light is toward the image source plane 171.

In Table 2, k represents the conic constant of the equation of aspheric surface profiles, and A2, A4, A6, A8, A10, A12, A14, A16, A18, and A20 represent the high-order aspheric coefficients.

The respective tables presented below for respective one of other embodiments are based on the schematic view of this embodiment, and the definitions of parameters in the tables are the same as those in Tables 1-4 of the first embodiment. Therefore, an explanation in this regard will not be provided again.

### Second Embodiment

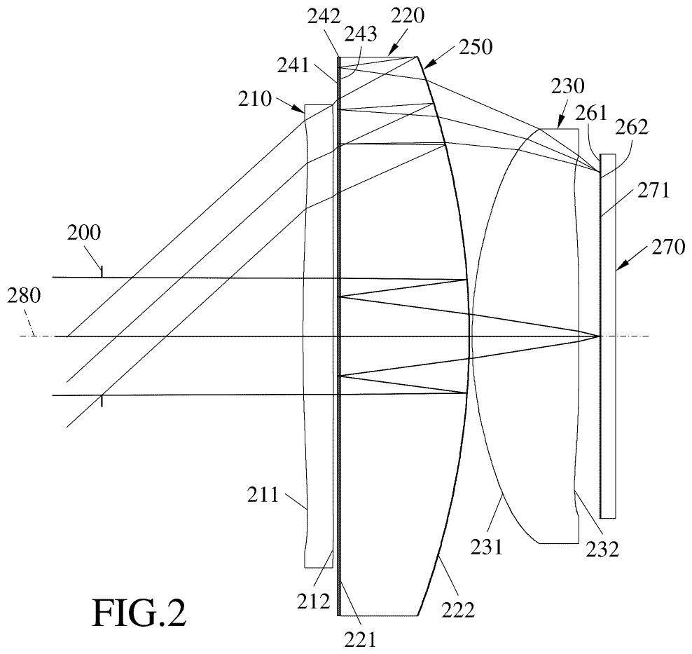

Referring to FIG. 2, an optical lens assembly in accordance with a second embodiment of the present invention includes, in order from a visual side to an image source side along an optical axis 280: a stop 200, a first lens 210, a first absorptive polarizer 241, a reflective polarizer 242, a first phase retarder 243, a second lens 220, a partial-reflective-partial-transmissive element 250, a third lens 230, a second phase retarder 261, a second absorptive polarizer 262 and an image source plane 271. The optical lens assembly has, for example, but not limited to, a total of three lenses with refractive power.

The configurations of the stop 200, the first absorptive polarizer 241, the reflective polarizer 242, the first phase retarder 243, the partial-reflective-partial-transmissive element 250, the second phase retarder 261, the second absorptive polarizer 262 and the image source plane 271 are the same as those of the stop 100, the first absorptive polarizer 141, the reflective polarizer 142, the first phase retarder 143, the partial-reflective-partial-transmissive element 150, the second phase retarder 161, the second absorptive polarizer 162 and the image source plane 171 of the first embodiment, and the configuration of an image source 270 in cooperation with the optical lens assembly may refer to that of the first embodiment and will not be explained again.

The first lens 210 with positive refractive power includes a visual-side surface 211 and an image source-side 212, the visual-side surface 211 of the first lens 210 is convex in a paraxial region thereof, the image source-side surface 212 of the first lens 210 is concave in a paraxial region thereof, the visual-side surface 211 and the image source-side surface 212 of the first lens 210 are aspheric, and the first lens 210 is made of plastic.

The second lens 220 with positive refractive power includes a visual-side surface 221 and an image source-side surface 222, the visual-side surface 221 of the second lens 220 is flat in a paraxial region thereof, the image source-side surface 222 of the second lens 220 is convex in a paraxial region thereof, the image source-side surface 222 of the second lens 220 is aspheric, and the second lens 220 is made of plastic.

The third lens 230 with positive refractive power includes a visual-side surface 231 and an image source-side surface 232, the visual-side surface 231 of the third lens 230 is convex in a paraxial region thereof, the image source-side surface 232 of the third lens 230 is convex in a paraxial region thereof, the visual-side surface 231 and the image source-side surface 232 of the third lens 230 are aspheric, and the third lens 230 is made of plastic.

Please refer to Tables 5-8, Table 5 shows the detailed optical data of the elements of the optical lens assembly of the second embodiment, Table 6 shows the aspheric coefficients of the aspherical surfaces of the elements of the optical lens assembly of the second embodiment, Table 7 shows the remaining parameters of the optical lens assembly of the second embodiment and the values thereof, and the values of the parameters in Tables 5 and 7 meet the conditional formulas of Table 8. In the second embodiment, the equation of the aspheric surface profiles of the aforementioned lenses is the same as the equation of the aspheric surface profiles of the aforementioned lenses in the first embodiment. The parameters and the definitions of the surfaces in Tables of the second embodiment are the same as those of Tables of the first embodiment and will not be explained again.

TABLE 5
f = 16.94 mm, EPD (entrance pupil diameter) = 9.00 mm, FOV = 90.14°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 14.000 | — | — | — |
| 1 | First lens | 160.137 | 2.103 | 1.544 | 55.9 | Refraction |
| 2 | | 1076.967 | 0.200 | — | — | Refraction |
| 3 | First absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | First phase | Infinity | 0.100 | 1.533 | 56.0 | Refraction |
| | retarder | | | | | |
| 6 | Second lens | Infinity | 8.966 | 1.544 | 55.9 | Refraction |
| 7 | Partial- | −64.895 | −8.966 | Mirror | | Reflection |
| | reflective-partial- | | | | | |
| | transmissive | | | | | |
| | element | | | | | |
| 8 | First phase | Infinity | −0.100 | 1.533 | 56.0 | Refraction |
| | retarder | | | | | |
| 9 | Reflective | Infinity | −0.100 | 1.533 | 56.0 | Refraction |
| 10 | polarizer | Infinity | 0.100 | Mirror | | Reflection |
| 11 | First phase | Infinity | 0.100 | 1.533 | 56.0 | Refraction |
| | retarder | | | | | |
| 12 | Second lens | Infinity | 8.966 | 1.544 | 55.9 | Refraction |
| 13 | Partial- | −64.895 | 0.200 | — | — | Refraction |
| | reflective-partial- | | | | | |
| | transmissive | | | | | |
| | element | | | | | |
| 14 | Third lens | 34.360 | 7.434 | 1.544 | 55.9 | Refraction |
| 15 | | −374.531 | 1.319 | — | — | Refraction |
| 16 | Second phase | Infinity | 0.100 | 1.533 | 56.0 | Refraction |
| | retarder | | | | | |
| 17 | Second | Infinity | 0.100 | 1.533 | 56.0 | Refraction |
| | absorptive | | | | | |
| | polarizer | | | | | |
| 18 | Image source | Infinity | — | — | — | — |
| | plane | | | | | |

The reference wavelength is 550 nm.

TABLE 6
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | −1.5437E−05 | −1.0553E−05 | 0.0000E+00 |
| A6: | −6.3491E−09 | −3.4984E−08 | 0.0000E+00 |
| A8: | 1.9169E−09 | 2.1214E−09 | 0.0000E+00 |
| A10: | −2.0080E−11 | −1.9095E−11 | 0.0000E+00 |
| A12: | 9.1266E−14 | 7.9041E−14 | 0.0000E+00 |
| A14: | −2.0100E−16 | −1.6119E−16 | 0.0000E+00 |
| A16: | 1.7101E−19 | 1.3071E−19 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 7, 13 | 14 | 15 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 5.2685E−07 | 1.4107E−06 | −1.9908E−05 |
| A6: | 1.2257E−09 | −8.3580E−08 | 1.0575E−06 |
| A8: | −3.4395E−11 | 1.6151E−09 | −3.4810E−08 |
| A10: | 2.3123E−13 | −2.8791E−11 | 4.5484E−10 |
| A12: | −7.1022E−16 | 2.4900E−13 | −2.7601E−12 |
| A14: | 1.0338E−18 | −9.3655E−16 | 7.8415E−15 |
| A16: | −5.9268E−22 | 1.3194E−18 | −8.1304E−18 |
| A18: | 0.0000E+00 | 0.0000E+00 | 0.0000E+00 |
| A20: | 0.0000E+00 | 0.0000E+00 | 0.0000E+00 |

TABLE 7

| | | | | | | | |
|---|---|---|---|---|---|---|---|
| f1[mm] | 343.13 | T12[mm] | 0.20 | R5[mm] | 34.36 | TL[mm] | 20.72 |
| f2[mm] | 118.47 | CT2[mm] | 8.97 | TDP4[mm] | 3.00 | BFL[mm] | 1.52 |
| f3[mm] | 57.83 | CT3[mm] | 7.43 | TDP5[mm] | 4.68 | IMH[mm] | 12.56 |
| CT1[mm] | 2.10 | R4[mm] | −64.89 | CA4[mm] | 42.90 | — | — |

TABLE 8

| | | | | | |
|---|---|---|---|---|---|
| TDP4/TDP5 | 0.64 | R5/CT3 | 4.62 | (R4/TDP4) + | −14.27 |
| | | | | (R5/TDP5) | |
| f/IMH | 1.35 | CA4/f | 2.53 | FOV/f[°/mm] | 5.32 |
| TL/IMH | 1.65 | R4/R5 | −1.89 | CA4*(TL − | 65.60 |
| | | | | BFL)/ | |
| | | | | IMH[mm] | |
| TL*IMH/FOV | 2.89 | CT2/CT3 | 1.21 | — | — |
| [mm²/°] | | | | | |
| (CT1 + T12 + | 0.54 | (CT1 + CT2)/ | 1.24 | — | — |
| CT2)/TL | | (CT3 + BFL) | | | |

### Third Embodiment

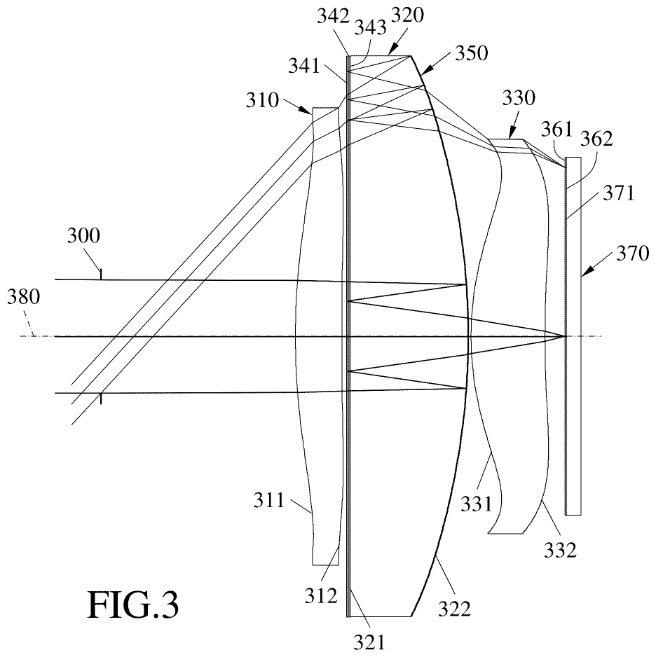

Referring to FIG. 3, an optical lens assembly in accordance with a third embodiment of the present invention includes, in order from a visual side to an image source side along an optical axis 380: a stop 300, a first lens 310, a first absorptive polarizer 341, a reflective polarizer 342, a first phase retarder 343, a second lens 320, a partial-reflective-partial-transmissive element 350, a third lens 330, a second phase retarder 361, a second absorptive polarizer 362 and an image source plane 371. The optical lens assembly has, for example, but not limited to, a total of three lenses with refractive power.

The configurations of the stop 300, the first absorptive polarizer 341, the reflective polarizer 342, the first phase retarder 343, the partial-reflective-partial-transmissive element 350, the second phase retarder 361, the second absorptive polarizer 362 and the image source plane 371 are the same as those of the stop 100, the first absorptive polarizer 141, the reflective polarizer 142, the first phase retarder 143, the partial-reflective-partial-transmissive element 150, the second phase retarder 161, the second absorptive polarizer 162 and the image source plane 171 of the first embodiment, and the configuration of an image source 370 in cooperation with the optical lens assembly may refer to that of the first embodiment and will not be explained again.

The first lens 310 with positive refractive power includes a visual-side surface 311 and an image source-side 312, the visual-side surface 311 of the first lens 310 is convex in a paraxial region thereof, the image source-side surface 312 of the first lens 310 is concave in a paraxial region thereof, the visual-side surface 311 and the image source-side surface 312 of the first lens 310 are aspheric, and the first lens 310 is made of plastic.

The second lens 320 with positive refractive power includes a visual-side surface 321 and an image source-side surface 322, the visual-side surface 321 of the second lens 320 is flat in a paraxial region thereof, the image source-side surface 322 of the second lens 320 is convex in a paraxial region thereof, the image source-side surface 322 of the second lens 320 is aspheric, and the second lens 320 is made of plastic.

The third lens 330 with positive refractive power includes a visual-side surface 331 and an image source-side surface 332, the visual-side surface 331 of the third lens 330 is convex in a paraxial region thereof, the image source-side surface 332 of the third lens 330 is concave in a paraxial region thereof, the visual-side surface 331 and the image source-side surface 332 of the third lens 330 are aspheric, and the third lens 330 is made of plastic.

Please refer to Tables 9-12, Table 9 shows the detailed optical data of the elements of the optical lens assembly of the third embodiment, Table 10 shows the aspheric coefficients of the aspherical surfaces of the elements of the optical lens assembly of the third embodiment, Table 11 shows the remaining parameters of the optical lens assembly of the third embodiment and the values thereof, and the values of the parameters in Tables 9 and 11 meet the conditional formulas of Table 12. In the third embodiment, the equation of the aspheric surface profiles of the aforementioned lenses is the same as the equation of the aspheric surface profiles of the aforementioned lenses in the first embodiment. The parameters and the definitions of the surfaces in Tables of the third embodiment are the same as those of Tables of the first embodiment and will not be explained again.

TABLE 9
f =16.09 mm, EPD (entrance pupil diameter) = 9.00 mm, FOV = 100.34°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 14.000 | — | — | — |
| 1 | First lens | 61.743 | 3.359 | 1.544 | 55.9 | Refraction |
| 2 | | 629.147 | 0.286 | — | — | Refraction |
| 3 | First absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | First phase | Infinity | 0.100 | 1.533 | 56.0 | Refraction |
| | retarder | | | | | |
| 6 | Second lens | Infinity | 8.522 | 1.544 | 55.9 | Refraction |
| 7 | Partial-reflective- | −63.663 | −8.522 | Mirror | | Reflection |
| | partial- | | | | | |
| | transmissive | | | | | |
| | element | | | | | |
| 8 | First phase | Infinity | −0.100 | 1.533 | 56.0 | Refraction |
| | retarder | | | | | |
| 9 | Reflective | Infinity | −0.100 | 1.533 | 56.0 | Refraction |
| 10 | polarizer | Infinity | 0.100 | Mirror | | Reflection |
| 11 | First phase | Infinity | 0.100 | 1.533 | 56.0 | Refraction |
| | retarder | | | | | |
| 12 | Second lens | Infinity | 8.522 | 1.544 | 55.9 | Refraction |
| 13 | Partial-reflective- | −63.663 | 0.200 | — | — | Refraction |
| | partial- | | | | | |
| | transmissive | | | | | |
| | element | | | | | |
| 14 | Third lens | 26.766 | 5.328 | 1.544 | 55.9 | Refraction |
| 15 | | 92.365 | 1.319 | — | — | Refraction |
| 16 | Second phase | Infinity | 0.100 | 1.533 | 56.0 | Refraction |
| | retarder | | | | | |
| 17 | Second | Infinity | 0.100 | 1.533 | 56.0 | Refraction |
| | absorptive | | | | | |
| | polarizer | | | | | |
| 18 | Image source | Infinity | — | — | — | — |
| | plane | | | | | |

The reference wavelength is 550 nm.

TABLE 10
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 2.8982E−07 | 7.5051E−06 | 0.0000E+00 |
| A6: | −3.3526E−08 | −3.1924E−09 | 0.0000E+00 |
| A8: | −9.0573E−10 | −1.4883E−09 | 0.0000E+00 |
| A10: | 9.3430E−12 | 1.1963E−11 | 0.0000E+00 |
| A12: | −4.1508E−14 | −4.3607E−14 | 0.0000E+00 |
| A14: | 9.0427E−17 | 8.0605E−17 | 0.0000E+00 |
| A16: | −8.0626E−20 | −5.9774E−20 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 7, 13 | 14 | 15 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 2.1584E−07 | −5.8699E−06 | −1.2781E−05 |
| A6: | −5.3403E−09 | −3.1850E−07 | −1.9447E−07 |
| A8: | 8.2324E−11 | 1.8722E−09 | 1.9260E−10 |
| A10: | −3.8453E−13 | −3.0422E−13 | 0.0000E+00 |
| A12: | 8.4584E−16 | −9.7352E−14 | 0.0000E+00 |
| A14: | −1.0056E−18 | 4.2643E−16 | 0.0000E+00 |
| A16: | 5.1576E−22 | −5.2455E−19 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 11

| | | | | | | | |
|---|---|---|---|---|---|---|---|
| f1[mm] | 124.72 | T12[mm] | 0.29 | R5[mm] | 26.77 | TL[mm] | 19.51 |
| f2[mm] | 116.22 | CT2[mm] | 8.52 | TDP4[mm] | 3.04 | BFL[mm] | 1.52 |
| f3[mm] | 66.88 | CT3[mm] | 5.33 | TDP5[mm] | 1.21 | IMH[mm] | 13.40 |
| CT1[mm] | 3.36 | R4[mm] | −63.66 | CA4[mm] | 44.60 | — | — |

TABLE 12

| | | | | | |
|---|---|---|---|---|---|
| TDP4/TDP5 | 2.52 | R5/CT3 | 5.02 | (R4/TDP4) + | 1.27 |
| | | | | (R5/TDP5) | |
| f/IMH | 1.20 | CA4/f | 2.77 | FOV/f[°/mm] | 6.24 |
| TL/IMH | 1.46 | R4/R5 | −2.38 | CA4*(TL − | 59.89 |
| | | | | BFL)/IMH[mm] | |
| TL*IMH/FOV | 2.61 | CT2/CT3 | 1.60 | — | — |
| [mm²/°] | | | | | |
| (CT1 + T12 + | 0.62 | (CT1 + CT2)/ | 1.74 | — | — |
| CT2)/TL | | (CT3 + BFL) | | | |

### Fourth Embodiment

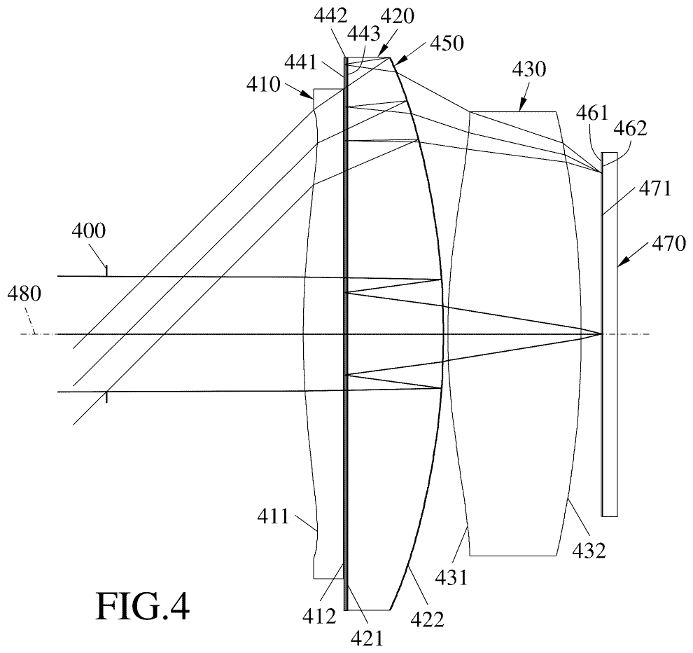

Referring to FIG. 4, an optical lens assembly in accordance with a fourth embodiment of the present invention includes, in order from a visual side to an image source side along an optical axis 480: a stop 400, a first lens 410, a first absorptive polarizer 441, a reflective polarizer 442, a first phase retarder 443, a second lens 420, a partial-reflective-partial-transmissive element 450, a third lens 430, a second phase retarder 461, a second absorptive polarizer 462 and an image source plane 471. The optical lens assembly has, for example, but not limited to, a total of three lenses with refractive power.

The configurations of the stop 400, the first absorptive polarizer 441, the reflective polarizer 442, the first phase retarder 443, the partial-reflective-partial-transmissive element 450, the second phase retarder 461, the second absorptive polarizer 462 and the image source plane 471 are the same as those of the stop 100, the first absorptive polarizer 141, the reflective polarizer 142, the first phase retarder 143, the partial-reflective-partial-transmissive element 150, the second phase retarder 161, the second absorptive polarizer 162 and the image source plane 171 of the first embodiment, and the configuration of an image source 470 in cooperation with the optical lens assembly may refer to that of the first embodiment and will not be explained again.

The first lens 410 with positive refractive power includes a visual-side surface 411 and an image source-side 412, the visual-side surface 411 of the first lens 410 is convex in a paraxial region thereof, the image source-side surface 412 of the first lens 410 is flat in a paraxial region thereof, the visual-side surface 411 of the first lens 410 is aspheric, the image source-side surface 412 of the first lens 410 is jointed with a visual-side surface of the first absorptive polarizer 441, and the first lens 410 is made of plastic.

The second lens 420 with positive refractive power includes a visual-side surface 421 and an image source-side surface 422, the visual-side surface 421 of the second lens 420 is flat in a paraxial region thereof, the image source-side surface 422 of the second lens 420 is convex in a paraxial region thereof, the image source-side surface 422 of the second lens 420 is aspheric, and the second lens 420 is made of plastic.

The third lens 430 with positive refractive power includes a visual-side surface 431 and an image source-side surface 432, the visual-side surface 431 of the third lens 430 is convex in a paraxial region thereof, the image source-side surface 432 of the third lens 430 is convex in a paraxial region thereof, the visual-side surface 431 of the third lens 430 is aspheric, the image source-side surface 432 of the third lens 430 is spherical, and the third lens 430 is made of plastic.

Please refer to Tables 13-16, Table 13 shows the detailed optical data of the elements of the optical lens assembly of the fourth embodiment, Table 14 shows the aspheric coefficients of the aspherical surfaces of the elements of the optical lens assembly of the fourth embodiment, Table 15 shows the remaining parameters of the optical lens assembly of the fourth embodiment and the values thereof, and the values of the parameters in Tables 13 and 15 meet the conditional formulas of Table 16. In the fourth embodiment, the equation of the aspheric surface profiles of the aforementioned lenses is the same as the equation of the aspheric surface profiles of the aforementioned lenses in the first embodiment. The parameters and the definitions of the surfaces in Tables of the fourth embodiment are the same as those of Tables of the first embodiment and will not be explained again.

TABLE 13
f = 16.35 mm, EPD (entrance pupil diameter) = 9.00 mm, FOV = 95.20°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 14.000 | — | — | — |
| 1 | First lens | 81.377 | 2.825 | 1.544 | 55.9 | Refraction |
| 2 | | Infinity | 0.000 | — | — | Refraction |
| 3 | First absorptive | Infinity | 0.100 | 1.533 | 56.0 | Refraction |
| | polarizer | | | | | |
| 4 | Reflective polarizer | Infinity | 0.100 | 1.533 | 56.0 | Refraction |
| 5 | First phase | Infinity | 0.100 | 1.533 | 56.0 | Refraction |
| | retarder | | | | | |
| 6 | Second lens | Infinity | 6.796 | 1.544 | 55.9 | Refraction |
| 7 | Partial-reflective- | −65.743 | −6.796 | Mirror | | Reflection |
| | partial-transmissive | | | | | |
| | element | | | | | |
| 8 | First phase | Infinity | −0.100 | 1.533 | 56.0 | Refraction |
| | retarder | | | | | |
| 9 | Reflective polarizer | Infinity | −0.100 | 1.533 | 56.0 | Refraction |
| 10 | | Infinity | 0.100 | Mirror | | Reflection |
| 11 | First phase | Infinity | 0.100 | 1.533 | 56.0 | Refraction |
| | retarder | | | | | |
| 12 | Second lens | Infinity | 6.796 | 1.544 | 55.9 | Refraction |
| 13 | Partial-reflective- | −65.743 | 0.306 | — | — | Refraction |
| | partial-transmissive | | | | | |
| | element | | | | | |
| 14 | Third lens | 55.510 | 9.475 | 1.544 | 55.9 | Refraction |
| 15 | | −86.098 | 1.327 | — | — | Refraction |
| 16 | Second phase | Infinity | 0.100 | 1.533 | 56.0 | Refraction |
| | retarder | | | | | |
| 17 | Second absorptive | Infinity | 0.100 | 1.533 | 56.0 | Refraction |
| | polarizer | | | | | |
| 18 | Image source | Infinity | — | — | — | — |
| | plane | | | | | |

The reference wavelength is 550 nm.

TABLE 14
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | −9.8469E−06 | 0.0000E+00 | 0.0000E+00 |
| A6: | 7.8658E−08 | 0.0000E+00 | 0.0000E+00 |
| A8: | −7.5869E−10 | 0.0000E+00 | 0.0000E+00 |
| A10: | 4.5363E−12 | 0.0000E+00 | 0.0000E+00 |
| A12: | −1.9396E−14 | 0.0000E+00 | 0.0000E+00 |
| A14: | 4.6333E−17 | 0.0000E+00 | 0.0000E+00 |
| A16: | −4.8559E−20 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 7, 13 | 14 | 15 |
|---|---|---|---|
| K: | 9.0844E−01 | 0.0000E+00 | 0.0000E+00 |
| A2: | 0.0000E+00 | 0.0000E+00 | 0.0000E+00 |
| A4: | 4.7874E−07 | −1.2566E−05 | 0.0000E+00 |
| A6: | −6.7504E−12 | −5.8861E−08 | 0.0000E+00 |
| A8: | 1.9936E−11 | 8.4547E−10 | 0.0000E+00 |
| A10: | −1.1446E−13 | −5.0391E−12 | 0.0000E+00 |
| A12: | 2.4329E−16 | 1.6653E−14 | 0.0000E+00 |
| A14: | −3.3291E−19 | −3.3636E−17 | 0.0000E+00 |
| A16: | 2.3214E−22 | 3.2357E−20 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 15

| | | | | | | | |
|---|---|---|---|---|---|---|---|
| f1[mm] | 148.56 | T12[mm] | 0.00 | R5[mm] | 55.51 | TL[mm] | 21.23 |
| f2[mm] | 120.02 | CT2[mm] | 6.80 | TDP4[mm] | 3.34 | BFL[mm] | 1.53 |
| f3[mm] | 63.11 | CT3[mm] | 9.48 | TDP5[mm] | 1.56 | IMH[mm] | 12.56 |
| CT1[mm] | 2.83 | R4[mm] | −65.74 | CA4[mm] | 43.20 | — | — |

TABLE 16

| | | | | | |
|---|---|---|---|---|---|
| TDP4/TDP5 | 2.14 | R5/CT3 | 5.86 | (R4/TDP4) + | 15.84 |
| | | | | (R5/TDP5) | |
| f/IMH | 1.30 | CA4/f | 2.64 | FOV/f[°/mm] | 5.82 |
| TL/IMH | 1.69 | R4/R5 | −1.18 | CA4*(TL − | 67.77 |
| | | | | BFL)/IMH[mm] | |
| TL*IMH/FOV | 2.80 | CT2/CT3 | 0.72 | — | — |
| [mm²/°] | | | | | |
| (CT1 + T12 + | 0.45 | (CT1 + CT2)/ | 0.87 | — | — |
| CT2)/TL | | (CT3 + BFL) | | | |

### Fifth Embodiment

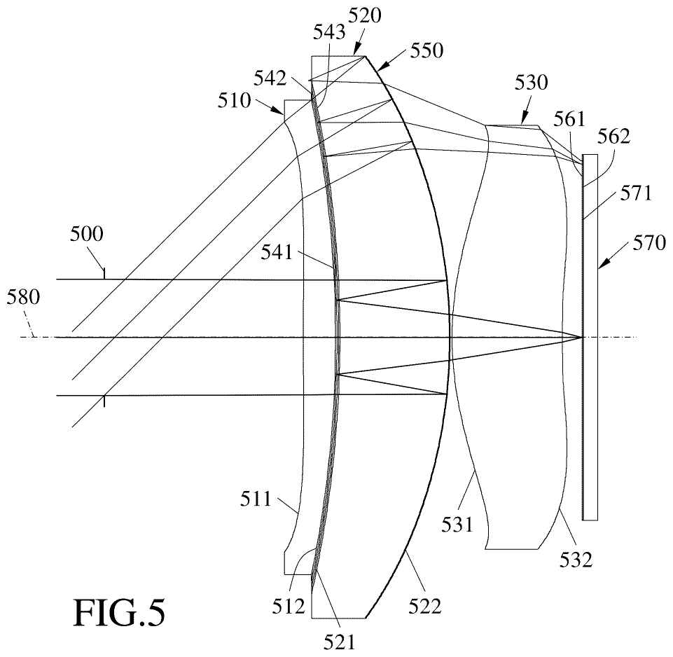

Referring to FIG. 5, an optical lens assembly in accordance with a fifth embodiment of the present invention includes, in order from a visual side to an image source side along an optical axis 580: a stop 500, a first lens 510, a first absorptive polarizer 541, a reflective polarizer 542, a first phase retarder 543, a second lens 520, a partial-reflective-partial-transmissive element 550, a third lens 530, a second phase retarder 561, a second absorptive polarizer 562 and an image source plane 571. The optical lens assembly has, for example, but not limited to, a total of three lenses with refractive power.

The configurations of the stop 500, the first absorptive polarizer 541, the reflective polarizer 542, the first phase retarder 543, the partial-reflective-partial-transmissive element 550, the second phase retarder 561, the second absorptive polarizer 562 and the image source plane 571 are the same as those of the stop 100, the first absorptive polarizer 141, the reflective polarizer 142, the first phase retarder 143, the partial-reflective-partial-transmissive element 150, the second phase retarder 161, the second absorptive polarizer 162 and the image source plane 171 of the first embodiment, and the configuration of an image source 570 in cooperation with the optical lens assembly may refer to that of the first embodiment and will not be explained again.

The first lens 510 with positive refractive power includes a visual-side surface 511 and an image source-side 512, the visual-side surface 511 of the first lens 510 is convex in a paraxial region thereof, the image source-side surface 512 of the first lens 510 is convex in a paraxial region thereof, the visual-side surface 511 of the first lens 510 is aspheric, the image source-side surface 512 of the first lens 510 is spherical, the image source-side surface 512 of the first lens 510 is jointed with a visual-side surface of the first absorptive polarizer 541, and the first lens 510 is made of plastic.

The second lens 520 with positive refractive power includes a visual-side surface 521 and an image source-side surface 522, the visual-side surface 521 of the second lens 520 is concave in a paraxial region thereof, the image source-side surface 522 of the second lens 520 is convex in a paraxial region thereof, the visual-side surface 521 of the second lens 520 is spherical, the image source-side surface 522 of the second lens 520 is aspheric, and the second lens 520 is made of plastic.

The third lens 530 with positive refractive power includes a visual-side surface 531 and an image source-side surface 532, the visual-side surface 531 of the third lens 530 is convex in a paraxial region thereof, the image source-side surface 532 of the third lens 530 is concave in a paraxial region thereof, the visual-side surface 531 and the image source-side surface 532 of the third lens 530 are aspheric, and the third lens 530 is made of plastic.

Please refer to Tables 17-20, Table 17 shows the detailed optical data of the elements of the optical lens assembly of the fifth embodiment, Table 18 shows the aspheric coefficients of the aspherical surfaces of the elements of the optical lens assembly of the fifth embodiment, Table 19 shows the remaining parameters of the optical lens assembly of the fifth embodiment and the values thereof, and the values of the parameters in Tables 17 and 19 meet the conditional formulas of Table 20. In the fifth embodiment, the equation of the aspheric surface profiles of the aforementioned lenses is the same as the equation of the aspheric surface profiles of the aforementioned lenses in the first embodiment. The parameters and the definitions of the surfaces in Tables of the fifth embodiment are the same as those of Tables of the first embodiment and will not be explained again.

TABLE 17
f = 16.98 mm, EPD (entrance pupil diameter) = 9.00 mm, FOV = 95.07°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 14.000 | — | — | — |
| 1 | First lens | 298.550 | 2.281 | 1.544 | 55.9 | Refraction |
| 2 | | −99.991 | 0.000 | — | — | Refraction |
| 3 | First absorptive | −99.991 | 0.100 | 1.533 | 56.0 | Refraction |
| | polarizer | | | | | |
| 4 | Reflective | −99.991 | 0.100 | 1.533 | 56.0 | Refraction |
| | polarizer | | | | | |
| 5 | First phase | −99.991 | 0.100 | 1.533 | 56.0 | Refraction |
| | retarder | | | | | |
| 6 | Second lens | −99.991 | 7.739 | 1.544 | 55.9 | Refraction |
| 7 | Partial- | −46.889 | −7.739 | Mirror | | Reflection |
| | reflective-partial- | | | | | |
| | transmissive | | | | | |
| | element | | | | | |
| 8 | First phase | −99.991 | −0.100 | 1.533 | 56.0 | Refraction |
| | retarder | | | | | |
| 9 | Reflective | −99.991 | −0.100 | 1.533 | 56.0 | Refraction |
| 10 | polarizer | −99.991 | 0.100 | Mirror | | Reflection |
| 11 | First phase | −99.991 | 0.100 | 1.533 | 56.0 | Refraction |
| | retarder | | | | | |
| 12 | Second lens | −99.991 | 7.739 | 1.544 | 55.9 | Refraction |
| 13 | Partial- | −46.889 | 0.160 | — | — | Refraction |
| | reflective-partial- | | | | | |
| | transmissive | | | | | |
| | element | | | | | |
| 14 | Third lens | 28.166 | 7.752 | 1.544 | 55.9 | Refraction |
| 15 | | 91.125 | 1.289 | — | — | Refraction |
| 16 | Second phase | Infinity | 0.100 | 1.533 | 56.0 | Refraction |
| | retarder | | | | | |
| 17 | Second | Infinity | 0.100 | 1.533 | 56.0 | Refraction |
| | absorptive | | | | | |
| | polarizer | | | | | |
| 18 | Image source | Infinity | — | — | — | — |
| | plane | | | | | |

The reference wavelength is 550 nm.

TABLE 18
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | −2.7104E−05 | 0.0000E+00 | 0.0000E+00 |
| A6: | 1.4816E−07 | 0.0000E+00 | 0.0000E+00 |
| A8: | −9.7409E−10 | 0.0000E+00 | 0.0000E+00 |
| A10: | 3.3685E−12 | 0.0000E+00 | 0.0000E+00 |
| A12: | −7.6451E−15 | 0.0000E+00 | 0.0000E+00 |
| A14: | 1.1288E−17 | 0.0000E+00 | 0.0000E+00 |
| A16: | −1.5846E−20 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 7, 13 | 14 | 15 |
|---|---|---|---|
| K: | 1.0255E+00 | 0.0000E+00 | 0.0000E+00 |
| A2: | 0.0000E+00 | 0.0000E+00 | 0.0000E+00 |
| A4: | −1.2997E−06 | −2.6410E−05 | 1.5253E−04 |
| A6: | 2.7616E−09 | −6.3344E−08 | −5.0846E−06 |
| A8: | 2.8114E−11 | 8.9956E−11 | 6.2748E−08 |
| A10: | −2.2720E−13 | 7.1469E−12 | −4.3660E−10 |
| A12: | 7.1805E−16 | −6.8662E−14 | 1.7401E−12 |
| A14: | −1.1235E−18 | 2.3072E−16 | −3.7037E−15 |
| A16: | 7.0603E−22 | −2.8557E−19 | 3.2587E−18 |
| A18: | 0.0000E+00 | 0.0000E+00 | 0.0000E+00 |
| A20: | 0.0000E+00 | 0.0000E+00 | 0.0000E+00 |

TABLE 19

| | | | | | | | |
|---|---|---|---|---|---|---|---|
| f1[mm] | 137.02 | T12[mm] | 0.00 | R5[mm] | 28.17 | TL[mm] | 19.72 |
| f2[mm] | 87.61 | CT2[mm] | 7.74 | TDP4[mm] | 4.68 | BFL[mm] | 1.49 |
| f3[mm] | 71.32 | CT3[mm] | 7.75 | TDP5[mm] | 2.31 | IMH[mm] | 13.40 |
| CT1[mm] | 2.28 | R4[mm] | −46.89 | CA4[mm] | 43.60 | — | — |

TABLE 20

| | | | | | |
|---|---|---|---|---|---|
| TDP4/TDP5 | 2.02 | R5/CT3 | 3.63 | (R4/TDP4) + | 2.14 |
| | | | | (R5/TDP5) | |
| f/IMH | 1.27 | CA4/f | 2.57 | FOV/f[°/mm] | 5.60 |
| TL/IMH | 1.47 | R4/R5 | −1.66 | CA4*(TL − | 59.32 |
| | | | | BFL)/IMH[mm] | |
| TL*IMH/FOV | 2.78 | CT2/CT3 | 1.00 | — | — |
| [mm²/°] | | | | | |
| (CT1 + T12 + | 0.51 | (CT1 + CT2)/ | 1.08 | — | — |
| CT2)/TL | | (CT3 + BFL) | | | |

### Sixth Embodiment

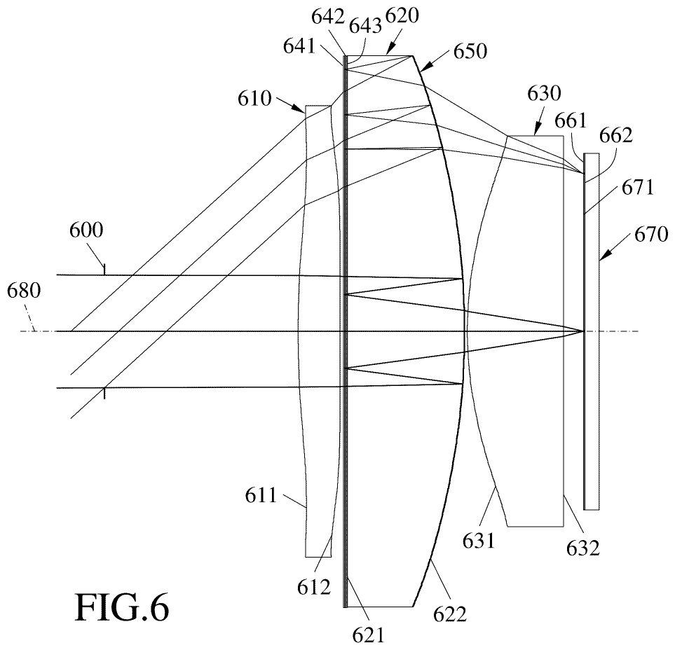

Referring to FIG. 6, an optical lens assembly in accordance with a sixth embodiment of the present invention includes, in order from a visual side to an image source side along an optical axis 680: a stop 600, a first lens 610, a first absorptive polarizer 641, a reflective polarizer 642, a first phase retarder 643, a second lens 620, a partial-reflective-partial-transmissive element 650, a third lens 630, a second phase retarder 661, a second absorptive polarizer 662 and an image source plane 671. The optical lens assembly has, for example, but not limited to, a total of three lenses with refractive power.

The configurations of the stop 600, the first absorptive polarizer 641, the reflective polarizer 642, the first phase retarder 643, the partial-reflective-partial-transmissive element 650, the second phase retarder 661, the second absorptive polarizer 662 and the image source plane 671 are the same as those of the stop 100, the first absorptive polarizer 141, the reflective polarizer 142, the first phase retarder 143, the partial-reflective-partial-transmissive element 150, the second phase retarder 161, the second absorptive polarizer 162 and the image source plane 171 of the first embodiment, and the configuration of an image source 570 in cooperation with the optical lens assembly may refer to that of the first embodiment and will not be explained again.

The first lens 610 with positive refractive power includes a visual-side surface 611 and an image source-side 612, the visual-side surface 611 of the first lens 610 is convex in a paraxial region thereof, the image source-side surface 612 of the first lens 610 is convex in a paraxial region thereof, the visual-side surface 611 and the image source-side surface 612 of the first lens 610 are aspheric, and the first lens 610 is made of plastic.

The second lens 620 with positive refractive power includes a visual-side surface 621 and an image source-side surface 622, the visual-side surface 621 of the second lens 620 is flat in a paraxial region thereof, the image source-side surface 622 of the second lens 620 is convex in a paraxial region thereof, the image source-side surface 622 of the second lens 620 is aspheric, and the second lens 620 is made of plastic.

The third lens 630 with positive refractive power includes a visual-side surface 631 and an image source-side surface 632, the visual-side surface 631 of the third lens 630 is convex in a paraxial region thereof, the image source-side surface 632 of the third lens 630 is flat in a paraxial region thereof, the visual-side surface 631 of the third lens 630 is aspheric, and the third lens 630 is made of plastic.

Please refer to Tables 21-24, Table 21 shows the detailed optical data of the elements of the optical lens assembly of the sixth embodiment, Table 22 shows the aspheric coefficients of the aspherical surfaces of the elements of the optical lens assembly of the sixth embodiment, Table 23 shows the remaining parameters of the optical lens assembly of the sixth embodiment and the values thereof, and the values of the parameters in Tables 21 and 23 meet the conditional formulas of Table 24. In the sixth embodiment, the equation of the aspheric surface profiles of the aforementioned lenses is the same as the equation of the aspheric surface profiles of the aforementioned lenses in the first embodiment. The parameters and the definitions of the surfaces in Tables of the sixth embodiment are the same as those of Tables of the first embodiment and will not be explained again.

TABLE 21
f = 16.74 mm, EPD (entrance pupil diameter) = 9.00 mm, FOV = 90.14°

| | | | | | Abbe | |
|---|---|---|---|---|---|---|
| | | Radius of | Thickness/ | Refractive | number | Refraction/ |
| Surface | | curvature | gap | index (nd) | (vd) | reflection |
| 0 | Stop | Infinity | 14.000 | — | — | — |
| 1 | First lens | 89.551 | 3.039 | 1.544 | 55.9 | Refraction |
| 2 | | −2026.898 | 0.200 | — | — | Refraction |
| 3 | First | Infinity | 0.100 | 1.533 | 56.0 | Refraction |
| | absorptive | | | | | |
| | polarizer | | | | | |
| 4 | Reflective | Infinity | 0.100 | 1.533 | 56.0 | Refraction |
| | polarizer | | | | | |
| 5 | First phase | Infinity | 0.100 | 1.533 | 56.0 | Refraction |
| | retarder | | | | | |
| 6 | Second lens | Infinity | 8.509 | 1.544 | 55.9 | Refraction |
| 7 | Partial- | −66.457 | −8.509 | Mirror | | Reflection |
| | reflective- | | | | | |
| | partial- | | | | | |
| | transmissive | | | | | |
| | element | | | | | |
| 8 | First phase | Infinity | −0.100 | 1.533 | 56.0 | Refraction |
| | retarder | | | | | |
| 9 | Reflective | Infinity | −0.100 | 1.533 | 56.0 | Refraction |
| 10 | polarizer | Infinity | 0.100 | Mirror | | Reflection |
| 11 | First phase | Infinity | 0.100 | 1.533 | 56.0 | Refraction |
| | retarder | | | | | |
| 12 | Second lens | Infinity | 8.509 | 1.544 | 55.9 | Refraction |
| 13 | Partial- | −66.457 | 0.200 | — | — | Refraction |
| | reflective- | | | | | |
| | partial- | | | | | |
| | transmissive | | | | | |
| | element | | | | | |
| 14 | Third lens | 33.877 | 6.955 | 1.544 | 55.9 | Refraction |
| 15 | | Infinity | 1.320 | — | — | Refraction |
| 16 | Second | Infinity | 0.100 | 1.533 | 56.0 | Refraction |
| | phase | | | | | |
| | retarder | | | | | |
| 17 | Second | Infinity | 0.100 | 1.533 | 56.0 | Refraction |
| | absorptive | | | | | |
| | polarizer | | | | | |
| 18 | Image | Infinity | — | — | — | — |
| | source | | | | | |
| | plane | | | | | |

The reference wavelength is 550 nm.

TABLE 22
Aspheric Coefficients

| Surface | 1 | 2 | 6, 12 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 9.7165E−06 | 2.1435E−05 | 0.0000E+00 |
| A6: | −3.9516E−07 | −4.6629E−07 | 0.0000E+00 |
| A8: | 3.4790E−09 | 3.3324E−09 | 0.0000E+00 |
| A10: | −1.9854E−11 | −1.5328E−11 | 0.0000E+00 |
| A12: | 7.1978E−14 | 4.7186E−14 | 0.0000E+00 |
| A14: | −1.4685E−16 | −8.2657E−17 | 0.0000E+00 |
| A16: | 1.2662E−19 | 6.1382E−20 | 0.0000E+00 |
| A18: | 0.0000E+00 | 0.0000E+00 | 0.0000E+00 |
| A20: | 0.0000E+00 | 0.0000E+00 | 0.0000E+00 |
| Surface | 7, 13 | 14 | 15 |
| K: | 0.0000E+00 | 0.0000E+00 | 0.0000E+00 |
| A2: | 0.0000E+00 | 0.0000E+00 | 0.0000E+00 |
| A4: | −8.1005E−07 | −1.9740E−05 | 0.0000E+00 |
| A6: | 1.2281E−08 | 1.0440E−07 | 0.0000E+00 |
| A8: | −2.8748E−11 | −5.9238E−10 | 0.0000E+00 |
| A10: | −2.9533E−14 | 5.1922E−12 | 0.0000E+00 |
| A12: | 1.9044E−16 | −4.0648E−14 | 0.0000E+00 |
| A14: | −2.7932E−19 | 1.3729E−16 | 0.0000E+00 |
| A16: | 1.4299E−22 | −1.7021E−19 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 23

| | | | | | | | |
|---|---|---|---|---|---|---|---|
| f1[mm] | 156.65 | T12[mm] | 0.20 | R5[mm] | 33.88 | TL[mm] | 20.72 |
| f2[mm] | 121.32 | CT2[mm] | 8.51 | TDP4[mm] | 2.92 | BFL[mm] | 1.52 |
| f3[mm] | 61.85 | CT3[mm] | 6.96 | TDP5[mm] | 2.90 | IMH[mm] | 12.56 |
| CT1[mm] | 3.04 | R4[mm] | −66.46 | CA4[mm] | 44.00 | — | — |

TABLE 24

| | | | | | |
|---|---|---|---|---|---|
| TDP4/TDP5 | 1.01 | R5/CT3 | 4.87 | (R4/TDP4) + | −11.10 |
| | | | | (R5/TDP5) | |
| f/IMH | 1.33 | CA4/f | 2.63 | FOV/f[°/mm] | 5.39 |
| TL/IMH | 1.65 | R4/R5 | −1.96 | CA4*(TL − | 67.27 |
| | | | | BFL)/ | |
| | | | | IMH[mm] | |
| TL*IMH/ | 2.89 | CT2/CT3 | 1.22 | — | — |
| FOV[mm²/°] | | | | | |
| (CT1 + T12 + | 0.57 | (CT1 + CT2)/ | 1.36 | — | — |
| CT2)/TL | | (CT3 + BFL) | | | |

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly.

For the optical lens assembly in the present invention, the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

For the optical lens assembly in the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

For the optical lens assembly in the present invention, the maximum effective radius of the lens surface is usually a radius of the effective optical region of the lens surface (i.e., a region which is not subjected to any surface treatment or extinction processing or is not provided with any shade).

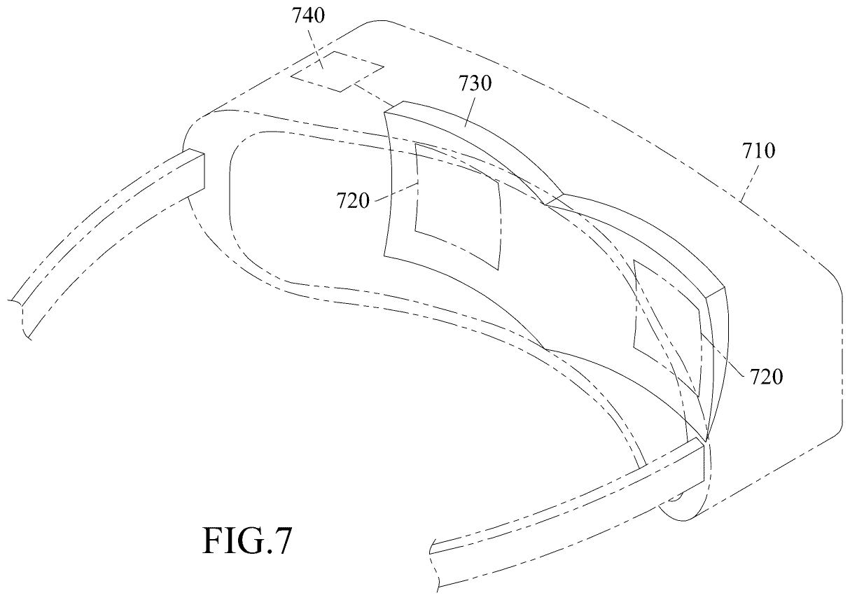

The optical lens assembly of the present invention can be used in an electronic device, for example, but not limited to a head-mounted electronic device. The head-mounted electronic device, for example, but not limited to a head-mounted display device. FIG. 7 shows a head-mounted display device in accordance with an embodiment of the present invention. The head-mounted display device using, but is not limited to, the virtual reality technology or mixed reality technology and includes a housing 710 and an optical module 720, an image source 9730 and a controller 740 disposed in the housing 710.

The optical module 720 corresponds to the left and right eyes of the user. The optical module 720 includes an optical lens assembly described in any one of the first to sixth embodiments.

The image source 730 can be an image source described in any one of the first to sixth embodiments. The image source 730 corresponds to the left and right eyes of the user, and the type of the image source 730 may be an OLED display, a LED display, a liquid crystal display, or other display, but is not limited thereto.

The controller 740 is electrically connected to the image source 730, so as to control the image source 730 to display an image, whereby the head-mounted display device can project the image to the eyes of the user.

What is claimed is:

1. An optical lens assembly comprising:
a first lens with positive refractive power, including a visual-side surface being convex in a paraxial region thereof;
a reflective polarizer;
a phase retarder;
a second lens with positive refractive power, including an image source-side surface being convex in a paraxial region thereof;
a partial-reflective-partial-transmissive element; and
a third lens with positive refractive power, including a visual-side surface being convex in a paraxial region thereof;
wherein the first lens, the reflective polarizer, the second lens, the partial-reflective-partial-transmissive element and the third lens are disposed in order from a visual side to an image source side, the phase retarder is disposed between the reflective polarizer and the partial-reflective-partial-transmissive element, an absolute value of a displacement in parallel to an optical axis from an intersection between the image source-side surface of the second lens and the optical axis to a maximum effective radius position on the image source-side surface of the second lens is TDP4, an absolute value of a displacement in parallel to the optical axis from an intersection between the visual-side surface of the third lens and the optical axis to a maximum effective radius position on the visual-side surface of the third lens is TDP5, and a following conditional formula is satisfied: 0.51<TDP4/TDP5<3.03.

2. The optical lens assembly as claimed in claim 1, wherein a focal length of the optical lens assembly is f, a maximum image height of the optical lens assembly is IMH, and a following conditional formula is satisfied: 0.96<f/IMH<1.62.

3. The optical lens assembly as claimed in claim 1, wherein a distance from the visual-side surface of the first lens to an image plane of the optical lens assembly along the optical axis is TL, a maximum image height of the optical lens assembly is IMH, and a following conditional formula is satisfied: 1.17<TL/IMH<2.03.

4. The optical lens assembly as claimed in claim 1, wherein a distance from the visual-side surface of the first lens to an image plane of the optical lens assembly along the optical axis is TL, a maximum image height of the optical lens assembly is IMH, a maximum field of view of the optical lens assembly is FOV, and a following conditional formula is satisfied: 1.99 mm²/°<TL*IMH/FOV<3.46 mm²/°.

5. The optical lens assembly as claimed in claim 1, wherein a distance from the visual-side surface of the first lens to an image plane of the optical lens assembly along the optical axis is TL, a thickness of the first lens along the optical axis is CT1, a thickness of the second lens along the optical axis is CT2, a distance from the first lens to the second lens along the optical axis is T12, and a following conditional formula is satisfied: 0.36<(CT1+T12+CT2)/TL<0.75.

6. The optical lens assembly as claimed in claim 1, wherein a radius of curvature of the visual-side surface of the third lens is R5, a thickness of the third lens along the optical axis is CT3, and a following conditional formula is satisfied: 2.91<R5/CT3<7.03.

7. The optical lens assembly as claimed in claim 1, wherein a maximum effective radius of the image source-side surface of the second lens is CA4, a focal length of the optical lens assembly is f, and a following conditional formula is satisfied: 2.03<CA4/f<3.33.

8. The optical lens assembly as claimed in claim 1, wherein a radius of curvature of the image source-side surface of the second lens is R4, a radius of curvature of the visual-side surface of the third lens is R5, and a following conditional formula is satisfied: −2.85<R4/R5<−0.95.

9. The optical lens assembly as claimed in claim 1, wherein a thickness of the second lens along the optical axis is CT2, a thickness of the third lens along the optical axis is CT3, and a following conditional formula is satisfied: 0.57<CT2/CT3<1.92.

10. The optical lens assembly as claimed in claim 1, wherein a thickness of the first lens along the optical axis is CT1, a thickness of the second lens along the optical axis is CT2, a thickness of the third lens along the optical axis is CT3, a distance from an image source-side surface of the third lens to an image plane of the optical lens assembly along the optical axis is BFL, and a following conditional formula is satisfied: 0.70< (CT1+CT2)/(CT3+BFL)<2.08.

11. The optical lens assembly as claimed in claim 1, wherein a radius of curvature of the image source-side surface of the second lens is R4, a radius of curvature of the visual-side surface of the third lens is R5, and a following conditional formula is satisfied: −17.13<(R4/TDP4)+(R5/TDP5)<19.00.

12. The optical lens assembly as claimed in claim 1, wherein a maximum field of view of the optical lens assembly is FOV, a focal length of the optical lens assembly is f, and a following conditional formula is satisfied: 4.26°/mm<FOV/f<7.48°/mm.

13. The optical lens assembly as claimed in claim 1, wherein a maximum effective radius of the image source-side surface of the second lens is CA4, a distance from the visual-side surface of the first lens to an image plane of the optical lens assembly along the optical axis is TL, a distance from an image source-side surface of the third lens to the image plane along the optical axis is BFL, a maximum image height of the optical lens assembly is IMH, and a following conditional formula is satisfied: 46.73 mm<CA4*(TL-BFL)/IMH<81.32 mm.

14. An electronic device, comprising:
a housing;
an optical lens assembly as claimed in claim 1 disposed in the housing;
an image source disposed on an image source plane of the optical lens assembly in the housing; and
a controller disposed in the housing and electrically connected to the image source.
